(19) United States
(12) Patent Application Publication
(10) Pub. No.: US 2018/0275281 A1
(43) Pub. Date: Sep. 27, 2018

(54) HIGH ORDER PHASE OPTIMIZED TRANSMISSION VIA GENERAL LAGRANGIAN MULTIPLIER

(71) Applicant: Northrop Grumman Systems Corporation, Falls Church, VA (US)

(72) Inventors: Daniel N. Liu, Torrance, CA (US); Alexander K. Tai, Torrance, CA (US)

(21) Appl. No.: 15/468,305

(22) Filed: Mar. 24, 2017

(51) Int. Cl. G01S 19/29; G01S 19/34; G01S 19/30

(52) U.S. Cl. CPC G01S 19/29; G01S 19/30; G01S 19/34

(57) ABSTRACT

A system and method of improving the modulation of GPS signal transmission is disclosed. Two alternative approaches are proposed: the Barrier Approximation and the Augmented Lagrangian Method. While both techniques can solve the problem with a substantially smaller error threshold, the Augmented Lagrangian Method further addresses potential ill-conditioning associated with nonconvex optimization. A formula for the lower bound on the constellation's amplitude is devised for any given arbitrary power profile. Lastly, additional results for multiplexing three, four, and five codes in GPS are presented. This invention also explores advantages and disadvantages for different solving strategies used. A discussion on how to generalize these techniques to non-POCET signal constellations is also included.

### BACKGROUND

The invention relates generally to modulation techniques in GPS signal transmission and in particular to the optimization of higher order constant envelope and non-constant envelope modulations.

Many types of modulation generate constant envelope signals. For example, phase shift keyed/phase modulated (PSK/PM), interplex modulation, and majority-vote modulation, among others. The power efficiency of these techniques is dependent on the relative power of the component signals. Finding a signal constellation that satisfies a set of power level constraints, phase difference constraints, and desired signal amplitudes is inherently a multidimensional nonconvex optimization problem, requiring optimization techniques to select the best solution that maximizes the power efficiency of signal transmission.

The original Phase Optimized Constant Envelope Transmission (POCET) optimization methodology optimizes the combining of several signals by using the penalty method for constrained optimization to compute phase tables, using a brute force approach with multiple parameters that had to be set empirically. The POCET methodology is described in several patents to Cahn and Dafesh: U.S. Pat. No. 8,774,315, U.S. Pat. No. 9,197,282 and U.S. Pat. No. 9,413,419. These patents describe an apparatus and method for computing optimal phase rotations by solving an optimization problem subject to intra-signal desired power constraints. A penalty function is used to solve the optimization problem.

However, the results of a POCET optimization are not unique in that multiple solutions are often permitted. Among these permitted solutions, one may be better suited than others given additional constraints, such as requirement of efficient hardware implementation. In addition, the penalty method has a high error threshold and does not determine the optimal solution consistently.

Thus, a need exists for improvements to the POCET methodology that have a substantially smaller error threshold, that address potential ill-conditioning associated with nonconvex optimization, and are better suited for handling higher order modulation, such as that which occurs when multiplexing any number of codes, for example, three, four and five codes, in a Global Positioning System (GPS).

### SUMMARY

In this invention, two alternative approaches are proposed to solving the problem: the Barrier Approximation and the Augmented Lagrangian Method. While both techniques can solve the problem with a substantially smaller error threshold, the Augmented Lagrangian Method further addresses potential ill-conditioning associated with nonconvex optimization. A formula for the lower bound on the constellation's amplitude is devised for any given arbitrary power profile. Lastly, additional results for multiplexing three, four, and five codes in GPS are presented. This invention also explores advantages and disadvantages for different solving strategies used. A discussion on how to generalize these techniques to non-POCET signal constellations is also included.

In an embodiment, the invention encompasses an apparatus for generating a composite signal from a plurality of component signals including a synthesizer configured to generate a carrier signal; a plurality of code generators for generating the plurality of component signals; an optimized lookup table generated through an optimization process that maximizes the power efficiency, subject to a plurality of intra-signal constraints for the component signal; and a modulator configured to modulate the carrier signal utilizing a finite set of composite signal amplitudes and phases from the optimized lookup table to combine three or more component signals from the plurality of code generators to generate the composite signal wherein said optimization process includes optimization of an objective function of the average power of the composite signal.

In another embodiment, the invention encompassea a method for generating a composite signal from a set of component signals including the steps of amplitude modulating and phase modulating a carrier signal with a modulator that uses a finite set of composite signal amplitudes and phases to combine three or more component signals; and determining with computation circuitry, the finite set of composite signal amplitudes and phases through an optimization process that maximizes power efficiency of the composite signal, subject to a plurality of intra-signal constraints for the component signals, wherein said optimization process includes optimization of an objective function of the average power of the composite signal.

In any of the above embodiments, the optimization process is further subject to any combination of the following: power constraints between component signals, phase constraints between component signals, amplitude requirements for the complex signal constellation, and desired power efficiency.

In any of the above embodiments, the composite signal can either be constant envelope, rectangular, or non-constant envelope.

In any of the above embodiments, the composite signal is an optimal solution to a nonconvex optimization problem.

In any of the above embodiments, the composite signal can be arbitrarily rotated by constant phase angle and can be arbitrarily scaled by a constant scalar to comprise the entire set of all optimal solutions.

In any of the above embodiments, the optimization procedure takes on the formulation of the Barrier Approximation Method or the Augmented Lagrangian Method.

### DESCRIPTION OF THE DRAWINGS

Features of example implementations of the invention will become apparent from the description, the claims, and the accompanying drawings in which:

FIG. 1A is a block diagram of a generic GPS modulator that can produce both constant envelope and non-constant envelope transmission signals according to the present invention.

FIG. 1B is a block diagram of a generalized optimization routine that produces an optimized signal constellation look-up table.

FIG. 2 shows a visual representation of convex and non-convex optimization problems.

FIGS. 3A-3C show the solution to 3 code POCET combination for a given set of power and phase constraints.

FIGS. 4A-4C show the solution to 4 code POCET combination for a given set of power and phase constraints.

FIGS. 5A-5C show the solution to 5 code POCET combination for a given set of power and phase constraints.

FIGS. 6A and 6B show the corresponding constellation amplitude for 3, 4, and 5 code POCET combinations, and compare it to the predicted lower bound.

FIGS. 7A-7C show the fully power efficient solution to 3 code non-POCET combination for a given set of power and phase constraints

FIGS. 8A-8C show a mediating solution to 3 code non-POCET combination for a given set of power and phase constraint.

### DETAILED DESCRIPTION

The POCET Optimization Problem is to compute a set of complex constellation points for any given power profile and phase constraints on a set of GPS navigation codes. The phases must be chosen so that the entire amplitude of a transmitted signal remains constant, as in MPSK modulation. However, because of power requirements of each individual code, the phases of each code are not equally distant from each other as one would normally expect in MPSK. Instead they are skewed in accordance to the optimized phase table.

The POCET Optimization Problem is restated as follows:

Minimize A(θ) subject to the conditions:

Pdₙ=|corrₙ(θ)|²

Im{e^{jΔø}^{ₙₗ}corrₙ(θ)corrᵢ*(θ)}=0,

Re{e^{jΔø}^{ₙₗ}corrₙ(θ)corrᵢ*(θ)}<0, (1)

Where A(θ) is the constant envelope of the phase-modulated carrier and correlation and power efficiency are defined as follows:

$$\begin{matrix}{corr}_{n} ( θ ) = \frac{A}{{2}^{N}} {Σ}_{k = 0}^{{2}^{N - 1}} [ 2 {b}_{n} ( k ) - 1 ] {e}^{j {θ}_{k}} , & ( 2 ) \\ η = \frac{{Σ}_{n = 1}^{N} \vert {corr}_{n} ( θ ) {\vert}^{2}}{{A}^{2}} & ( 3 )\end{matrix}$$

Here, corrₙ(θ) is the correlation function, or the average product of the complex constellation point and the corresponding chip, while η is the power efficiency, or the ratio between the total correlation power and the signal power.

In the above notation, N is the number of codes being combined (e.g. 3), θ is a vector containing all of the phase-optimized angles, Pdₙ is the desired power level for code n (e.g. −3 dB), bₙ(k) is the binary chip value (0 or 1) of code n at index k, and Δϕₙₗ is the phase difference between codes n and l (e.g. 90°). Although the amplitude function to minimize A(θ) is not given, it can be implicitly derived from the definition of the correlation function.

The POCET Optimization Problem is a nonconvex optimization problem. It is originally presented as a constrained nonlinear optimization problem. But from a practical perspective, the distinction should designate whether the problem is convex or nonconvex. A convex optimization problem has a unique global minimum (and therefore no local minimum), whereas a nonconvex optimization problem is one which has multiple local minimum in addition to a global minimum. The main issue with nonconvex optimization problems is that after running an optimization routine, there is no way of knowing if the solution is indeed the global minimum being searched, or if it is just a local minimum in a particular region of the domain.

There are several techniques that can be used to solve problems that are constrained. One class of methods involves converting constrained problems into unconstrained problems. A variation of the penalty method is used to combine equality constraints and the original objective function to produce a new unconstrained objective function. The problem is still inherently nonconvex and a brute force approach is still needed to determine the two ideal penalty factors. This methodology is inefficient in a sense that running the search is exhaustive and requires throwing away any solution that violates the inequality constraints. It is also difficult to find a solution that is within a very small error threshold, for example, less than 10⁻⁵, depending on how the penalty factors are chosen. A smaller error threshold (such as 10⁻¹⁵) increases the likelihood that the solution found is indeed optimal according to the given constraints.

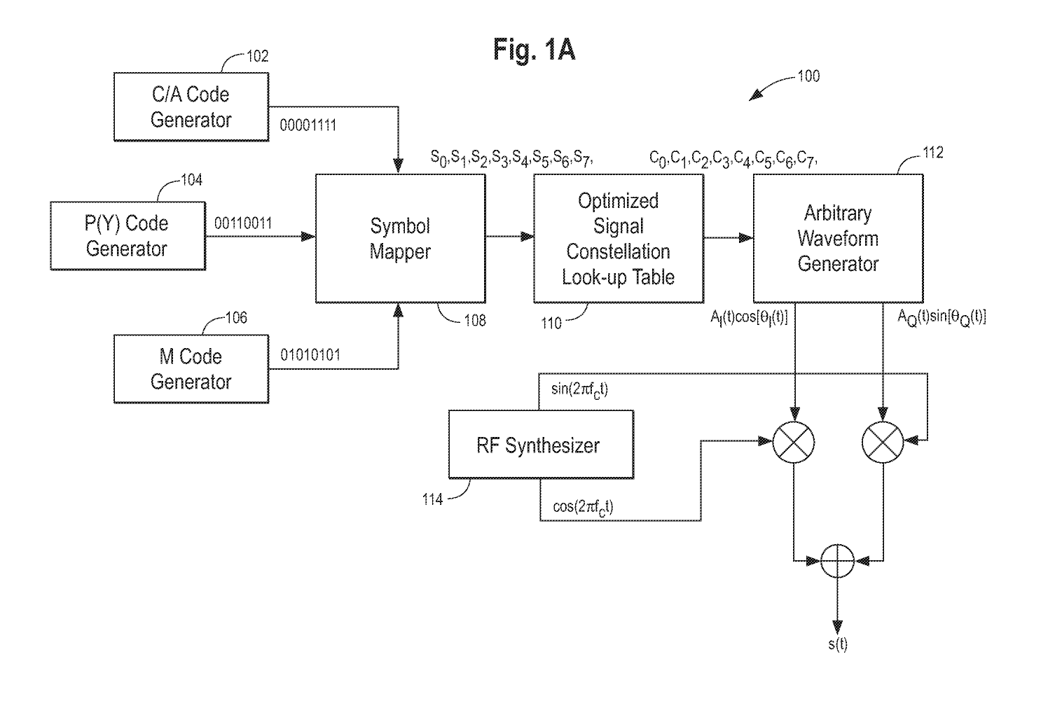

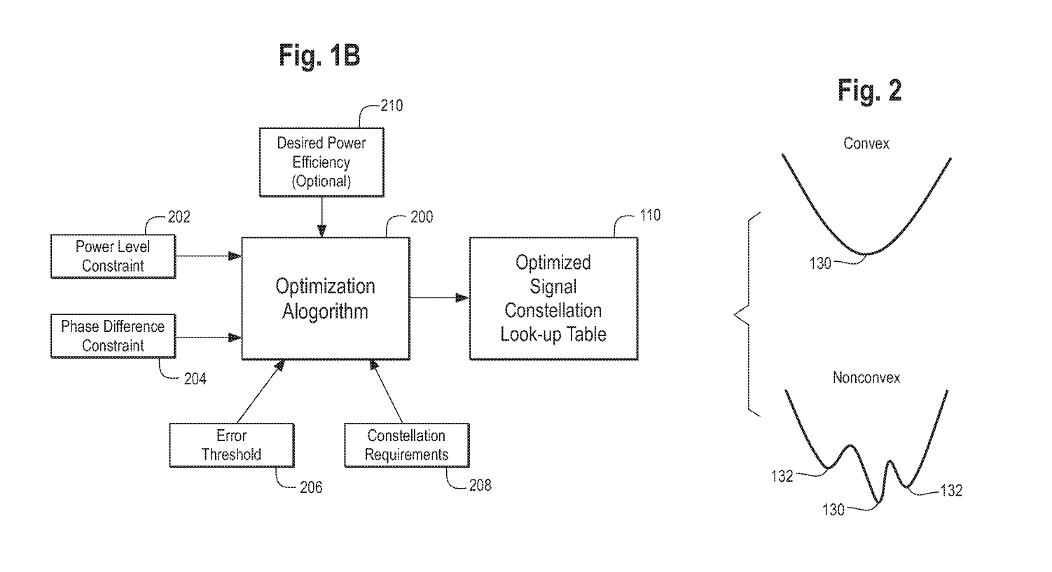

An apparatus 100 according to the present invention is shown in FIG. 1A. Three code generators typically found in GPS systems are shown as course/acquisition (C/A) Code generator 102, P(Y) code generator 104 and military (M) code generator 106. Although three code generators are shown, any number of code generators could also be used as well. The signals from code generators 102, 104 and 106 are input to a symbol mapper 108 that assigns each set of three bits a symbol index (s₀ through s₇). These symbol indices are then passed through an optimized signal constellation look-up table 110 which assigns each symbol index a complex signal constellation value (c₀ through c₇). The stream of complex valued symbols is then fed into an arbitrary waveform generator 112 which produces an in-phase baseband signal A_{I}(t)cos [θ_{I}(t)] and a quadrature baseband signal A_{Q}(t)sin [θ_{Q}(t)]. Lastly the baseband signal is placed on a carrier via RF synthesizer 114 to create a composite passband signal s(t).

A system that performs the optimization routine is shown in FIG. 1B. The optimization algorithm 200 receives the following inputs: power level constraints 202, phase difference constraints 204, error threshold 206, constellation requirements 208, and (optionally) desired power efficiency 210. The optimization routine then reshapes the problem into a single unconstrained equation using either the Barrier Approximation or the Augmented Lagrangian Method. The output of the optimization algorithm 200 is an optimized signal constellation look-up table 110 (of FIG. 1A) that may or may not be constant envelope.

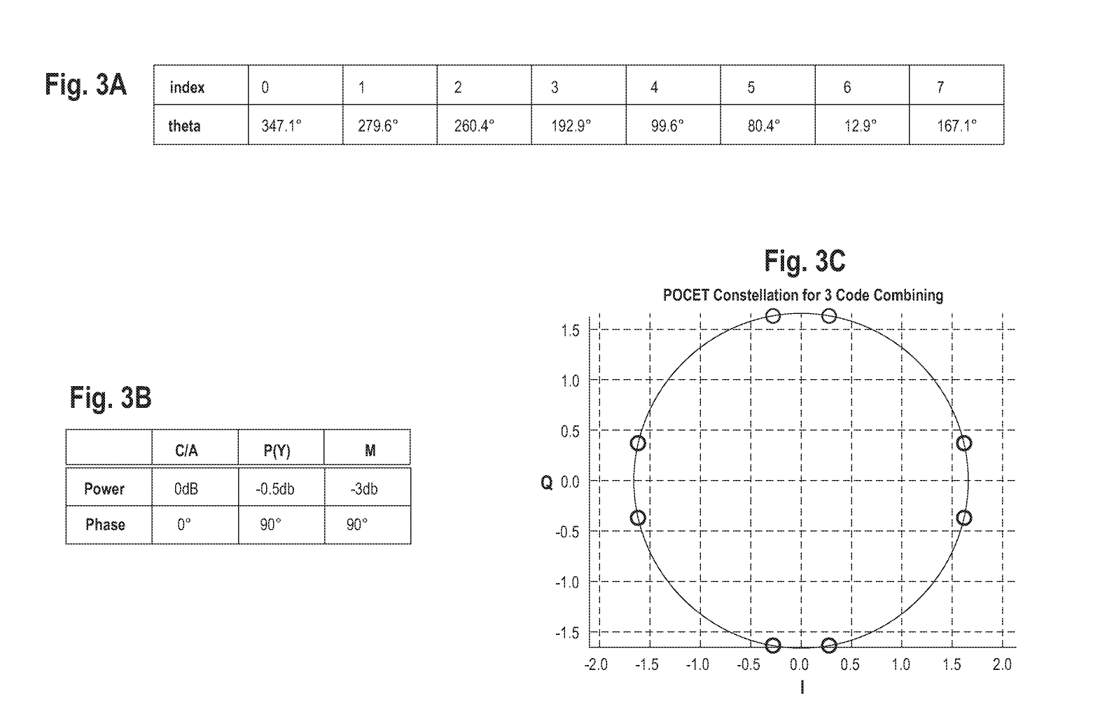

FIG. 2 shows a representation of convex and non-convex optimization problems. A convex problem is easier to solve since there is only one global minimum solution 130 to the function. On the other hand, a nonconvex problem will have a number of local minimums 132 in addition to the global minimum 130.

The Barrier Approximation

The first alternative examined is the Barrier Method which works in a similar fashion to the penalty method by combining both equality and inequality constraints into a new objective function. A slight modification is made in temporarily ignoring the original objective function. This effectively reduces to solving the feasibility problem in search for the set of solutions that satisfy all constraints. This will require collecting a large number of feasible solutions, followed by selecting the best solution from the set. Solving the problem this way also allows one to observe some of the behavior that occurs when the algorithm runs into local minimums. The same situation arises if the original objective function is included requiring multiple searches in the absence of convexity. Here is the Barrier approximation:

$$F ( θ ) = \frac{1}{2 ϵ} {{Σ}_{n} [ \vert {corr}_{n} ( θ ) \vert - {corrd}_{n} ]}^{2} + \frac{1}{2 ϵ} {Σ}_{n} {Σ}_{l} Im {\{ {e}^{j {Δ∅}_{nl}} {corr}_{n} ( θ ) {corr}_{i}^{*} ( θ ) \}}^{2} - {ϵΣ}_{n} {Σ}_{l} Im \vert Re \{ {e}^{j {Δ∅}_{nl}} {corr}_{n} ( θ ) {corr}_{i}^{*} ( θ ) \} \vert \qquad ( 4 )$$

In the above equation, corrdₙ is simply the square root of the desired power level of code n and ϵ is the Barrier parameter to be determined such that 0<ϵ<<1. Typically, ϵ is taken to be very small which gives a better approximation. However, making ϵ to be too small will make the problem ill-conditioned to solve. A fair choice is to set ϵ=10⁻⁴, but other values may be used.

In this optimization, the program is run repeatedly, for example, 100 times, until solutions are found. Then among those solutions that are feasible, the solution that gives the smallest value for A(θ) and the best power efficiency is picked. In the case of combining four codes, it is shown that A(θ)=1.8469 and η=0.8547, which is reasonably close to the original results in [1]. One difference is that this solution has a smaller error threshold around 10⁻¹⁰ compared to an error threshold of about 10⁻⁵ when using the penalty method. When running the search, there is only one fixed parameter to determine empirically.

The Augmented Lagrangian Method

The second alternative approach explored in the POCET Optimization Problem is a variation of Augmented Lagrangian Method introduced in [3]. Unlike the other two techniques, this method tries to make the new unconstrained problem look convex. It is shown in [2] that for any primal problem (even if it is nonconvex), the associated dual problem is always convex.

minimize f₀(θ) subject to fᵢ(θ)≤0, hᵢ(θ)=0. (5)

The Lagrangian Function is defined as:

L(θ;λ;μ)=f₀(θ)+Σᵢ₌₁^{m}λᵢfᵢ(θ)+Σᵢ₌₁^{p}μihi(θ) (6)

The convex objective function for the associated dual problem is obtained by taking the infimum of the Lagrangian function over θ. This is difficult to do analytically, so the Augmented Lagrangian Method sidesteps this by inserting slack variables and penalty terms to the equation.

$${L}_{aug} ( θ ; λ ; μ ) = {f}_{0} ( θ ) + {Σ}_{i = 1}^{m} {λ}_{i} [ {f}_{i} ( θ ) + {s}_{i} ] - \frac{1}{2 ϵ} {{Σ}_{i = 1}^{m} [ {f}_{i} ( θ ) + {s}_{i} ]}^{2} - {Σ}_{i = 1}^{p} {μ}_{i} {h}_{i} ( θ ) + \frac{1}{2 ϵ} {Σ}_{i = 1}^{m} {h}_{i}^{2} ( θ ) \qquad ( 7 )$$

Parameter ϵ is chosen in the same fashion as the Barrier Method. Here, λᵢ and μᵢ are the Lagrange Multipliers and sᵢ are the slack variables that are updated at each iteration as follows:

$$\begin{matrix}{λ}_{i}^{( k + 1 )} = max \{ {λ}_{i}^{( k )} + \frac{{f}_{i} ( {θ}^{( k )} )}{ϵ} , 0 \} & ( 8 ) \\ {μ}_{i}^{( k + 1 )} = {μ}_{i}^{( k )} - \frac{{h}_{i} ( {θ}^{( k )} )}{ϵ} & ( 9 ) \\ {s}_{i}^{( k + 1 )} = max \{ - {f}_{i} ( {θ}^{( k )} ) - {ϵλ}_{i}^{( k )} , 0 \} & ( 10 )\end{matrix}$$

In this optimization, the algorithm iteratively updates the Lagrange Multipliers and the slack variables at each stage until a solution is found satisfying a given error threshold. If the program reaches 100 iterations, the algorithm is reset at a new initial starting point to prevent an endless search in the current direction. If the parameter ϵ and the error threshold are chosen appropriately, then the program effectively returns the same answer. In the case of four code combining, the solution computed by the Augmented Lagrangian Method is essentially the same as the solutions computed by the other two methods with A(θ)=1.8469 and η=0.8547. The only significant difference is that the solution of the Augmented Lagrangian Method is more accurate in a sense that the error threshold is substantially smaller compared to the best error thresholds of the other two.

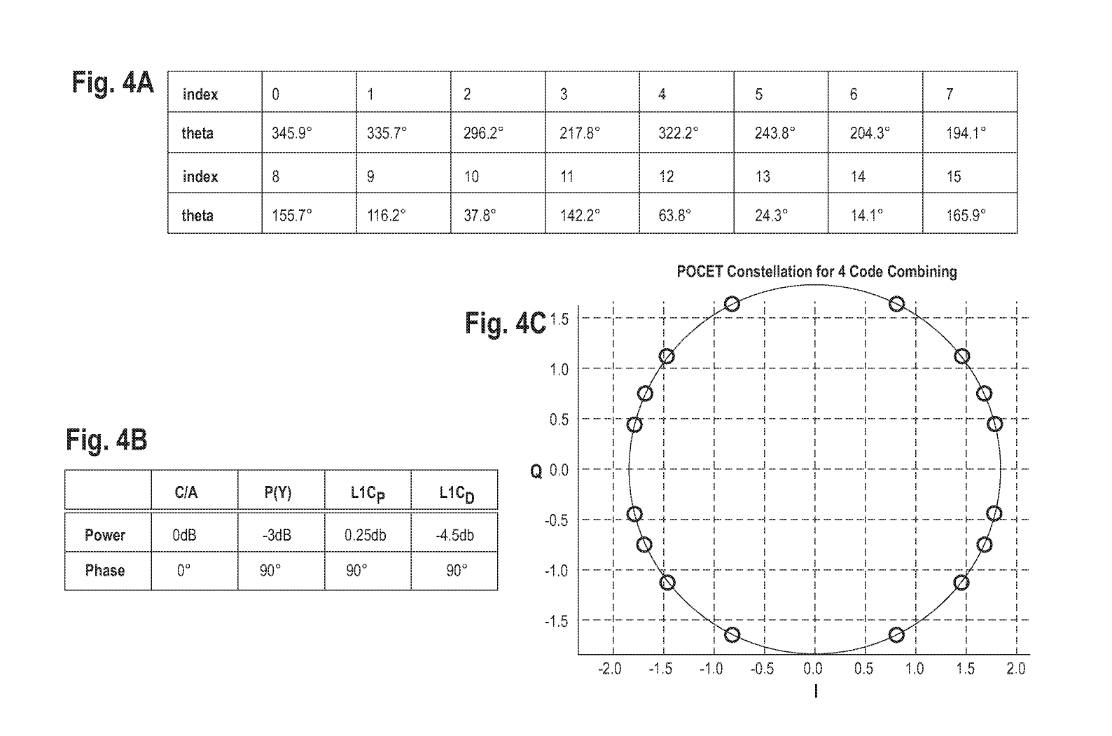

FIGS. 3A-3C show the solution to 3 code POCET combination using the Augmented Lagrangian Method for a given set of power and phase constraints. In the case of three codes, assume the C/A code determines the MSB (most significant bit), the P(Y) code determines the center bit and the M code determines the LSB (least significant bit), yielding [1,0,1]. This converts to decimal integer 5, denoted by index k in the table of FIG. 3A. Thus, the corresponding phase is 80.4° for this particular symbol s₅. FIG. 3B shows the desired power levels and phase relationships for the three codes. FIG. 3C depicts the resulting signal constellation of the combined three codes in the complex plane. The horizontal axis denotes the in-phase component and the vertical axis denotes the quadrature component. Assigning these power values and phase relationships results in a constant envelope A(θ) of 1.6541 and a power efficiency η of 0.8545.

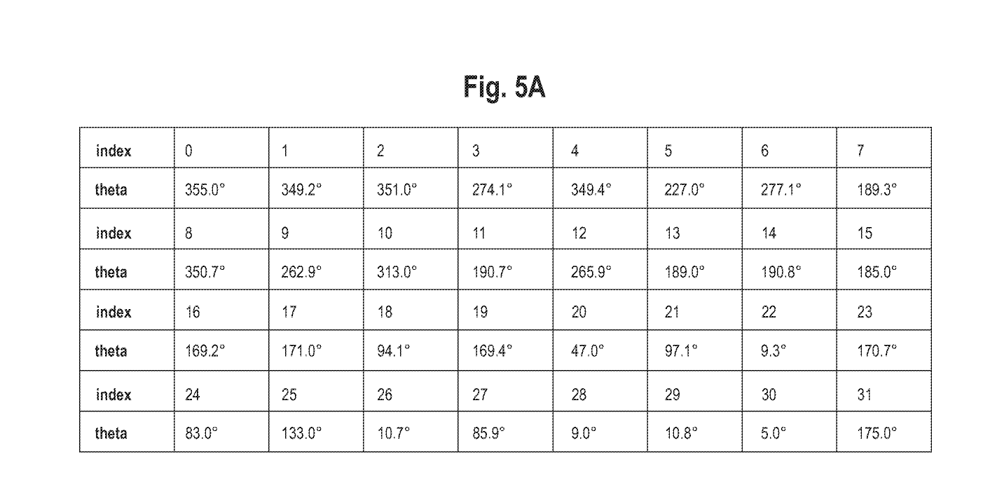

FIGS. 4A-4C show the solution to 4 code POCET combination using the Augmented Lagrangian Method for a given set of power and phase constraints. FIG. 4A shows the table of phase values for every combination of four codes, for example C/A, P(Y), L1C_{P} and L1C_{D}. FIG. 4B shows power and phase relationships among the four codes while FIG. 4C depicts the resulting signal constellation of the combined four codes in the complex plane. The horizontal axis denotes the in-phase component and the vertical axis denotes the quadrature component. Assigning these power values and phase relationships results in a constant envelope A(θ) of 1.8469 and a power efficiency η of 0.8547.

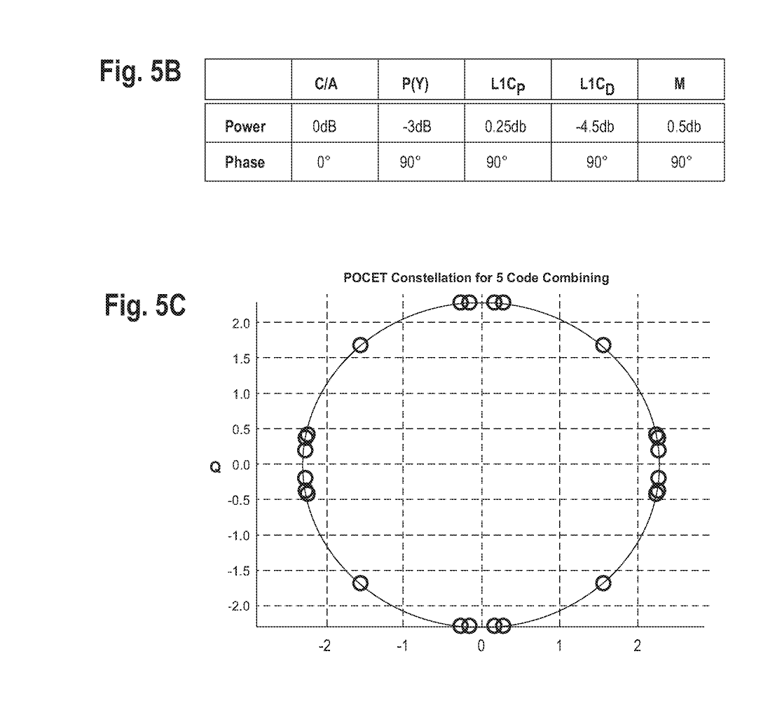

FIGS. 5A-5C show the solution to 5 code POCET combination using the Augmented Lagrangian Method for a given set of power and phase constraints. FIG. 5A shows the table of phase relationships for every combination of five codes, for example C/A, P(Y), L1C_{P}, L1C_{D} and M. FIG. 5B shows power and phase relationships for the five codes while FIG. 5C depicts the resulting signal constellation of the combined five codes in the complex plane. The horizontal axis denotes the in-phase component and the vertical axis denotes the quadrature component. Assigning these power values and phase relationships results in a constant envelope A(θ) of 2.282 and a power efficiency η of 0.7717.

The general POCET optimization described above admits multiple “optimal” answers, which means that multiple solutions exist to the same problem. For example, multiple solutions can arrive as follows: for any signal constellation formed from an optimized phase table, the constellation can be rotated by any phase φ and can also be scaled by any a. Rotating the constellation does not violate phase constraints from the optimization because the phase difference between navigation codes is relative. For example, the phase difference between C/A code and P(Y) code is 90°. Thus C/A code can be set at 0° and P(Y) at 90°. However, one could also set C/A at 45° and P(Y) at 135° and the optimization procedure will produce a phase table that has been rotated by 45°. Scaling the signal constellation also does not violate power constraints from the optimization because the power difference between navigation codes is relative. For example, the power difference between C/A code and P(Y) code is 3 dB. Normally, one would set C/A code at 0 dB and P(Y) code at −3 dB. However, one could also set C/A code at 3 dB and P(Y) code at 0 dB and the optimization procedure will produce a phase table that has been scaled by a factor of 2 (corresponding to a 3 dB gain). The solution originally presented in the prior art, was chosen such that the C/A code is forced to 0 dB and that the phases are symmetric in the complex plane.

Lower Bound Derivation

Since many optimization problems in engineering are inherently nonconvex, it is sometimes useful to have some benchmark to determine if the solution is indeed a global minimum as opposed to a local minimum. While this cannot be necessarily known, often times a lower bound can provide a qualitative comparison. Also such lower bounds are useful to examine how well the optimization routine performed. In the POCET Optimization Problem using the Augmented Lagrangian Method, a lower bound on A(θ) can be computed as follows: First, let η be the best power efficiency computed using A_{ideal} and θ_{ideal} returned from any optimization program.

$$η = \frac{{Σ}_{n = 1}^{N} \vert {corr}_{n} ( {θ}_{ideal} ) {\vert}^{2}}{{A}_{ideal}^{2}} \qquad ( 11 )$$

Next, assume that power efficiency can be no better than 100% so that η≤1. Evaluating at the critical value of η=1,

$$1 = \frac{{Σ}_{n = 1}^{N} \vert {corr}_{n} ( {θ}_{ideal} ) {\vert}^{2}}{{A}_{ideal}^{2}} \qquad ( 12 )$$

Rearranging this equation yields

A_{ideal}=\sqrt{Σₙ₌₁^{N}|corrₙ(θ_{ideal})|²} (13)

However, at the point of optimization, the total correlation power is the same as the total desired power. Replacing this term eliminates θ_{ideal}, so that a lower bound can be written as

A_{LB}=\sqrt{Σₙ₌₁^{N}Pdₙ} (14)

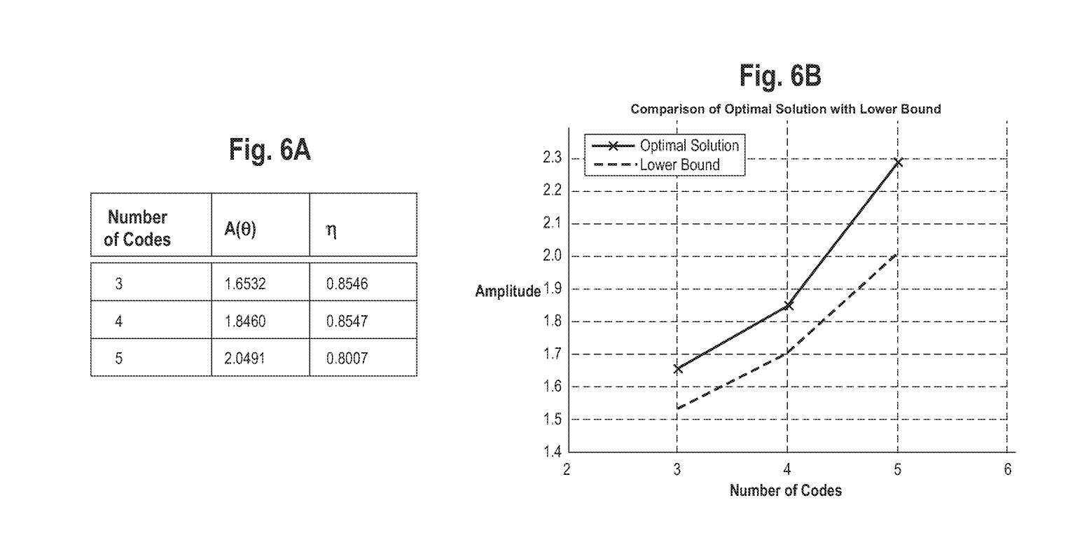

As an example, in the case of four codes combining, the program returns Aₒₚₜ=1.8469 and the corresponding lower bound is A_{LB}=1.7074, which is reasonably close to the computer value. Of course, one would expect different numbers if different power profiles are used. A graph is provided comparing lower bounds to the optimal values returned by the program for three scenarios. Corresponding constellation amplitude for 3, 4, and 5 code POCET combinations, and a comparison to the predicted lower bound, is shown in FIGS. 6A and 6B.

Non-POCET Solutions and Generalization

The optimization procedure can be generalized to obtain non-POCET solutions in which the amplitude is not constant. For example, one could drop the constant amplitude requirement and instead impose an arbitrary amplitude requirement or a desired power efficiency level to obtain a non-constant envelope signal constellation. Each symbol in the new signal constellation will have both unique amplitude and phase values.

Non-POCET Optimization can be generalized by redefining the correlation function and the power efficiency equation, and replacing A with the set {rₖ}.

$$\begin{matrix}{corr}_{n} ( r , θ ) = \frac{1}{{2}^{N}} {Σ}_{k = 0}^{{2}^{N - 1}} [ 2 {b}_{n} ( k ) - 1 ] {r}_{k} {e}^{j {θ}_{k} ,} & ( 15 ) \\ η = \frac{{Σ}_{n = 1}^{N} \vert {corr}_{n} ( r , θ ) {\vert}^{2}}{\frac{1}{{2}^{N}} {Σ}_{k = 1}^{{2}^{N - 1}} \vert {r}_{k} {\vert}^{2}} & ( 16 )\end{matrix}$$

The objective of maximizing power efficiency is the same and is again the equivalent of minimizing the denominator term:

$$min \{ \frac{1}{{2}^{N}} {Σ}_{k = 0}^{{2}^{N - 1}} \vert {r}_{k} {\vert}^{2} \} \qquad ( 17 )$$

subject to the following:

Pdₙ=|corrₙ(r,θ)²| (18)

Im{e^{jΔø}^{ₙₗ}corrₙ(r,θ)corrᵢ*(r,θ)}=0,

Re{e^{jΔø}^{ₙₗ}corrₙ(r,θ)corrᵢ*(r,θ)}<0,

In a further embodiment, a simplified version of the penalty method of optimization using only one parameter is give by:

$$F ( r , θ ) = \frac{1}{{2}^{N}} {Σ}_{k = 0}^{{2}^{N - 1}} \vert {r}_{k} {\vert}^{2} + \frac{1}{2 ϵ} {{Σ}_{n} [ {Pd}_{n} - \vert {corr}_{n} ( r , θ ) {\vert}^{2} ]}^{2} + \frac{1}{2 ϵ} {Σ}_{n} {Σ}_{l} Im {\{ {e}^{j {Δ∅}_{nl}} {corr}_{n} ( r , θ ) {{corr}_{l} ( r , θ )}^{*} \}}^{2} \qquad ( 19 )$$

where 0<ϵ<<1.

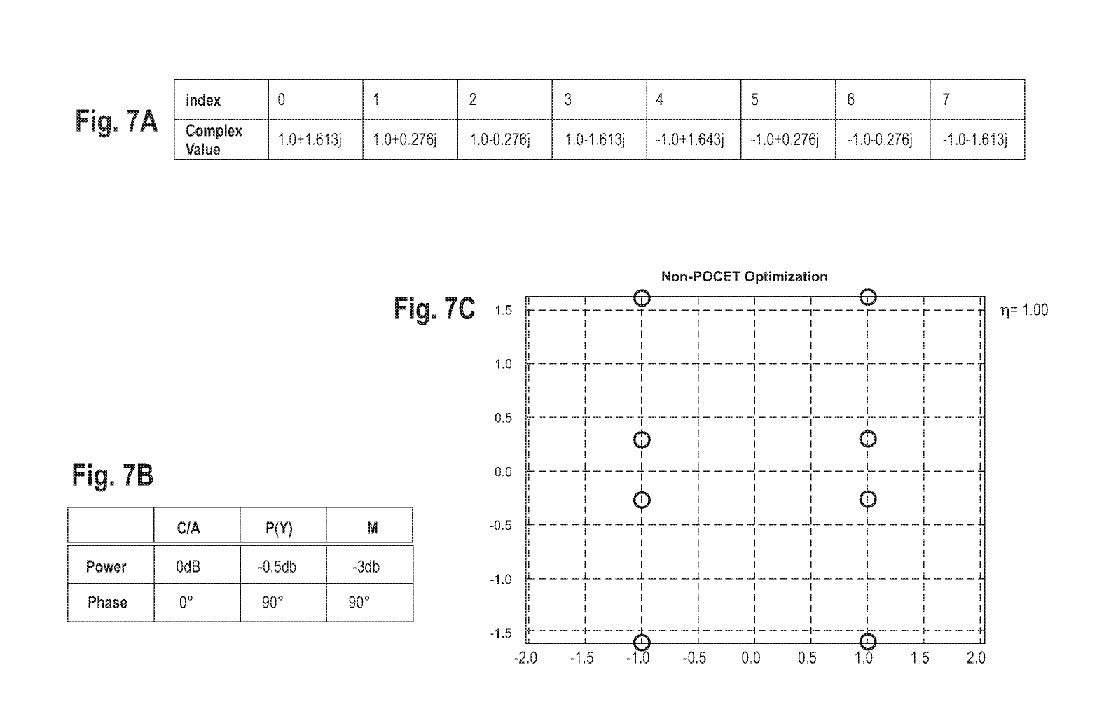

Similarly to FIGS. 3A-3C, FIGS. 7A-7C show the resulting signal constellation and solution to Non-POCET optimization that achieves full 100% power efficiency. As shown above, the best power efficiency is achieved by the Non-POCET solution for multiplexing GPS codes. Therefore, the price paid for requiring a constant amplitude as in the prior art POCET formulation is a loss in power efficiency. For any mediating solution between POCET and Non-POCET, it is necessary to have a well-defined objective function. One way to do this is to maximize power efficiency while enforcing a maximum power difference among the constellation points.

An intermediate problem can be achieved by enforcing an additional equality constraint such as:

max(rₖ)−min(rₖ)=Δᵣ (20)

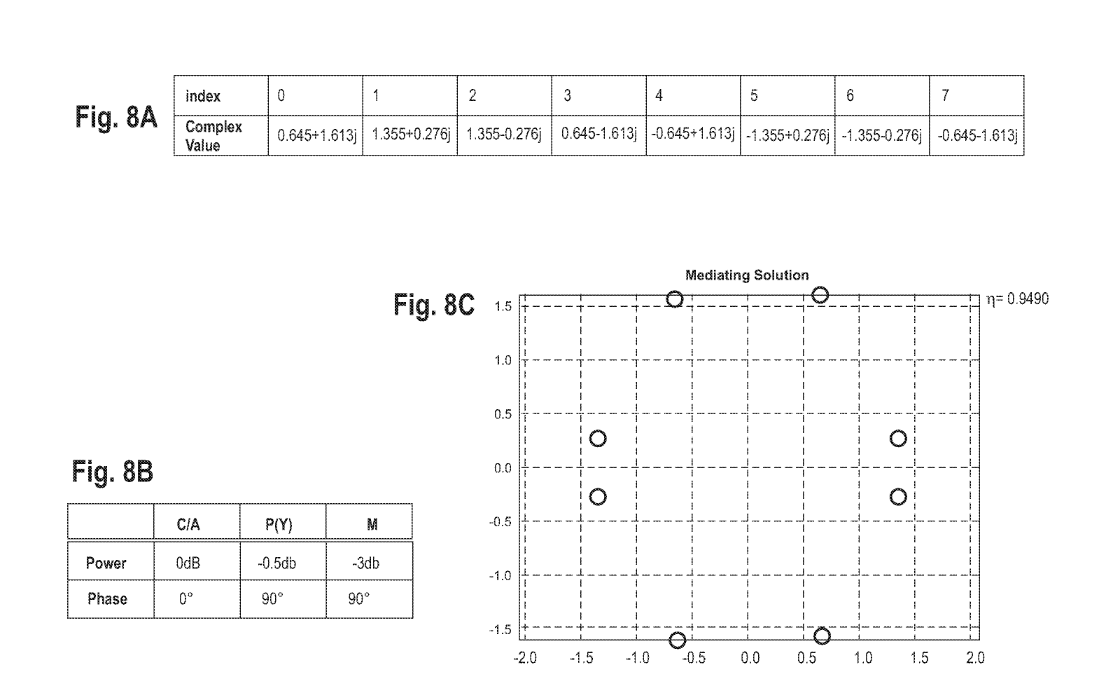

Omitting the Δᵣ constraint leads to the Non-POCET solution and setting Δᵣ=0 reverts back to the POCET solution. If A, is set to some arbitrarily small number, in principle this will result in better power efficiency (although not 100%) as compared to the POCET solution. For example, FIGS. 8A-8C show a constellation with Δᵣ=0.37, resulting in a mediating solution with η=94.90%.

In further embodiments, for any POCET, Non-POCET or mediating solution, the constellation may be arbitrarily scaled by a scaling factor a. In addition, the entire constellation may be rotated by some angle θₐ. In either of these cases, power profiles between codes and phase constraints are still maintained so effectively, each solution has an entire family of solutions.

The apparatus of FIG. 1 in one example comprises a plurality of components such as one or more of electronic components, hardware components, and computer software components. A number of such components can be combined or divided in the apparatus of FIG. 1. An example component of the apparatus of FIG. 1 employs and/or comprises a set and/or series of computer instructions written in or implemented with any of a number of programming languages, as will be appreciated by those skilled in the art.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus for generating a composite signal from a plurality of component signals, comprising:
a synthesizer configured to generate a carrier signal;
a plurality of code generators for generating the plurality of component signals;
an optimized lookup table generated through an optimization process that maximizes the power efficiency, subject to a plurality of intra-signal constraints for the component signal; and
a modulator configured to modulate the carrier signal utilizing a finite set of composite signal amplitudes and phases from the optimized lookup table to combine three or more component signals from the plurality of code generators to generate the composite signal;
wherein said optimization process includes optimization of an objective function of the average power of the composite signal.

2. The apparatus for generating a composite signal of claim 1, wherein the optimization process is further subject to any combination of the following: power constraints between component signals, phase constraints between component signals, amplitude requirements for the complex signal constellation, and desired power efficiency.

3. The apparatus for generating a composite signal of claim 1, wherein the composite signal can either be constant envelope, rectangular, or non-constant envelope.

4. The apparatus for generating a composite signal of claim 1, wherein the composite signal is an optimal solution to a nonconvex optimization problem.

5. The apparatus for generating a composite signal of claim 1, wherein the composite signal can be arbitrarily rotated by constant phase angle and can be arbitrarily scaled by a constant scalar to comprise the entire set of all optimal solutions.

6. The apparatus for generating a composite signal of claim 1, wherein the optimization procedure takes on the formulation of the Barrier Approximation Method.

7. The apparatus for generating a composite signal of claim 6, wherein the Barrier Approximation Method uses the equation:
$$F ( θ ) = \frac{1}{2 ϵ} {{Σ}_{n} [ \vert {corr}_{n} ( θ ) \vert - {corrd}_{n} ]}^{2} + \frac{1}{2 ϵ} {Σ}_{n} {Σ}_{l} Im {\{ {e}^{j {Δ∅}_{nl}} {corr}_{n} ( θ ) {corr}_{i}^{*} ( θ ) \}}^{2} - ϵ {\sum }_{n} {\sum }_{l} Im \vert Re \{ {e}^{j {Δ∅}_{nl}} {corr}_{n} ( θ ) {corr}_{i}^{*} ( θ ) \} \vert$$
where corrdₙ is the square root of the desired power level of code n and ϵ is the Barrier parameter to be determined such that 0<ϵ<<1.

8. The apparatus for generating a composite signal of claim 1, wherein the optimization procedure takes on the formulation of the Augmented Lagrangian Method.

9. The apparatus for generating a composite signal of claim 8, wherein the Augmented Lagrangian Method uses the equation:
$${L}_{aug} ( θ ; λ ; μ ) = {f}_{0} ( θ ) + {Σ}_{i = 1}^{m} {λ}_{i} [ {f}_{i} ( θ ) + {s}_{i} ] - \frac{1}{2 ϵ} {\sum }_{i = 1}^{m} {[ {f}_{i} ( θ ) + {s}_{i} ]}^{2} - {\sum }_{i = 1}^{p} {μ}_{i} {h}_{i} ( θ ) + \frac{1}{2 ϵ} {\sum }_{i = 1}^{m} {h}_{i}^{2} ( θ )$$
where ϵ to be determined such that 0<ϵ<<1 and
$${λ}_{i}^{( k + 1 )} = max \{ {λ}_{i}^{( k )} + \frac{{f}_{i} ( {θ}^{( k )} )}{ϵ} , 0 \} , \\ {μ}_{i}^{( k + 1 )} = {μ}_{i}^{( k )} - \frac{{h}_{i} ( {θ}^{( k )} )}{ϵ} , and$$
$${s}_{i}^{( k + 1 )} = max \{ - {f}_{i} ( {θ}^{( k )} ) - {ϵλ}_{i}^{( k )} , 0 \} .$$

10. A method for generating a composite signal from a set of component signals comprising the steps of:
amplitude modulating and phase modulating a carrier signal with a modulator that uses a finite set of composite signal amplitudes and phases to combine three or more component signals; and
determining with computation circuitry, the finite set of composite signal amplitudes and phases through an optimization process that maximizes power efficiency of the composite signal, subject to a plurality of intra-signal constraints for the component signals, wherein said optimization process includes optimization of an objective function of the average power of the composite signal.

11. The method for generating a composite signal of claim 10, wherein the optimization process is further subject to any combination of the following: power constraints between component signals, phase constraints between component signals, amplitude requirements for the complex signal constellation, and desired power efficiency.

12. The method for generating a composite signal of claim 10, wherein the composite signal can either be constant envelope, rectangular, or non-constant envelope.

13. The method for generating a composite signal of claim 10, wherein the composite signal is an optimal solution to a nonconvex optimization problem.

14. The method for generating a composite signal of claim 10, wherein the composite signal can be arbitrarily rotated by constant phase angle and can be arbitrarily scaled by a constant scalar to comprise the entire set of all optimal solutions.

15. The method for generating a composite signal of claim 10, wherein the optimization procedure takes on the formulation of the Barrier Approximation Method.

16. The method for generating a composite signal of claim 15, wherein the Barrier Approximation Method uses the equation:
$$F ( θ ) = \frac{1}{2 ϵ} {{Σ}_{n} [ \vert {corr}_{n} ( θ ) \vert - {corrd}_{n} ]}^{2} + \frac{1}{2 ϵ} {Σ}_{n} {Σ}_{l} Im {\{ {e}^{j {Δ∅}_{nl}} {corr}_{n} ( θ ) {corr}_{i}^{*} ( θ ) \}}^{2} - ϵ {\sum }_{n} {\sum }_{l} Im \vert Re \{ {e}^{j {Δ∅}_{nl}} {corr}_{n} ( θ ) {corr}_{i}^{*} ( θ ) \} \vert$$
where corrdₙ is the square root of the desired power level of code n and ϵ is the Barrier parameter to be determined such that 0<ϵ<<1.

17. The method for generating a composite signal of claim 10, wherein the optimization procedure takes on the formulation of the Augmented Lagrangian Method.

18. The method for generating a composite signal of claim 17, wherein the Augmented Lagrangian Method uses the equation:
$${L}_{aug} ( θ ; λ ; μ ) = {f}_{0} ( θ ) + {Σ}_{i = 1}^{m} {λ}_{i} [ {f}_{i} ( θ ) + {s}_{i} ] - \frac{1}{2 ϵ} {\sum }_{i = 1}^{m} {[ {f}_{i} ( θ ) + {s}_{i} ]}^{2} - {\sum }_{i = 1}^{p} {μ}_{i} {h}_{i} ( θ ) + \frac{1}{2 ϵ} {\sum }_{i = 1}^{m} {h}_{i}^{2} ( θ )$$
where ϵ to be determined such that 0<ϵ<<1 and
$${λ}_{i}^{( k + 1 )} = max \{ {λ}_{i}^{( k )} + \frac{{f}_{i} ( {θ}^{( k )} )}{ϵ} , 0 \} , \\ {μ}_{i}^{( k + 1 )} = {μ}_{i}^{( k )} - \frac{{h}_{i} ( {θ}^{( k )} )}{ϵ} , and$$
$${s}_{i}^{( k + 1 )} = max \{ - {f}_{i} ( {θ}^{( k )} ) - {ϵλ}_{i}^{( k )} , 0 \} .$$
